(19) United States
(12) Patent Application Publication
(10) Pub. No.: US 2018/0164893 A1
(43) Pub. Date: Jun. 14, 2018

(54) TRANSPORTATION MEANS, USER INTERFACE AND METHOD FOR ASSISTING A USER DURING INTERACTION WITH A USER INTERFACE

(71) Applicant: VOLSWAGEN AKTIENGESELLSCHAFT, Wolfsburg (DE)

(72) Inventors: Marcel SPERRHAKE, Erfurt (DE); Janine PERKUHN, Berlin (DE); Mathias STABLER, Berlin (DE)

(21) Appl. No.: 15/579,126

(22) PCT Filed: Apr. 15, 2016
(86) PCT No.: PCT/EP2016/058447

§ 371 Date: Dec. 1, 2017

(30) Foreign Application Priority Data
Jun. 2, 2015 (DE) 10 2015 210 130.4

(51) Int. Cl. G06F 3/01; B60K 35/00; B60K 37/06; G06F 3/0481

(52) U.S. Cl. CPC G06F 3/017; B60K 35/00; B60K 37/06; G06F 2203/04101; G06F 3/0481; B60K 2350/1052; G06F 3/011

(57) ABSTRACT

The invention relates to a transportation means, a user interface and a method for assisting a user during interaction with a user interface (1). The method comprises the steps: detecting a crossing motion of an input means (2) of the user in relation to a border of a detection region for detecting gestures freely executed in the area, and in response thereto, displaying this crossing motion by means of a light strip (8) in an edge region of a display device (4) of the user interface (1).

### PRIOR ART

The present invention relates to a transportation means, a user interface and a method for assisting a user during interaction with a user interface. In particular, the present invention relates to such a user interface in which gestures executed freely in space (“3-D gestures”) are used for input.

In order to operate a gesture-controlled interface, the free hand gestures to be detected by a sensor must be made within a specific area. This area delimited by sensors is difficult for the user to discern. Moreover, gestures made at different positions within the area are recognized with varying clarity.

In January 2015, the Volkswagen Group presented a user interface at the Consumer Electronics Show (CES) in which the user's hand is portrayed by a cursor on a display once the hand is located within the space monitored by sensors. The position of the hand within this space is transferred to the display. However, the use of a cursor suggests that deictic gestures can be used as well, in other words, objects can be directly manipulated. The solution is only suitable for a certain form of interaction, however.

US 2012/0260164 A1 discloses a shape-changing display arrangement that is configured like a touch screen for tactile input. Inter alia, it is proposed to acknowledge a chosen gesture by a visual response (the “highlight”).

DE 10 2012 216 193 A1 discloses a device for operating a motor vehicle component by means of gestures in which an entry of a display means in a sensor space provided for 3-D gesture detection is acknowledged acoustically, optically or haptically. A head-up display is proposed for optical output.

### DISCLOSURE OF THE INVENTION

The above-identified object is achieved according to the invention with a method for assisting a user during interaction with a user interface. In this method, in a first step, a crossing is detected of an input means (such as a stylus, hand, finger, smart watch, wearable) across a border of a detection area for detecting gestures (3-D gestures) executed freely in space. The detection area serves in particular for detecting such gestures that are made entirely without contacting a surface of a display unit of the user interface. Consequently, the detection area can in particular have a distance unequal to 0 mm from the surface of the display unit. The border of the detection area can be an outer border, or for example virtually delimit a core area lying within the detection area from an outer area. The crossing can occur as an entry into or exit out of the detection area. In response to the detected crossing, the crossing is identified, or respectively reported by a light strip in an edge area of the display apparatus of the user interface. The light strip has a length that is significantly greater than its cross-section. It can extend over a part of an edge or over the entire edge length of the display unit. The light strip can therefore be understood as a “light line”. The narrow dimensions of the light strip enable a particularly discrete type of feedback to the user that does not significantly consume the display area of the display apparatus. By arranging the light strip in the edge area of the display apparatus, it is rendered intuitively comprehensible that the gesture has exceeded a limit of the detection area without an explanatory symbol being necessary. Consequently, the user does not have to undergo a tedious learning process for correctly interpreting the light strip, which minimizes the associated distraction from traffic activity, or respectively from driving the vehicle, and optimally promotes traffic safety.

The dependent claims offer preferred developments of the invention.

In one embodiment, the light strip can be depicted by means of pixels in the display apparatus. In this manner, an additional lighting apparatus bordering the display apparatus can be dispensed with, and the method according to the invention can be implemented particularly economically.

Alternatively or in addition, a separate apparatus comprising illuminants (such as LEDs) and possibly light guides/diffusers for generating the light strip can be provided whose light outlets border the display apparatus. In this manner, the light intensity can be selected independent of a luminosity of the display apparatus, and the display surface of the display apparatus can be used for different optional content.

Preferably, the light strip can only be displayed during the period of crossing. In other words, a transitional state can be recognized that for example lasts from a first point in time at which the input means first enters the border area to a second point in time at which the display means completely leaves the border area. Between the aforementioned points in time, the display means is located uninterruptedly within the border area, and the light strip is only generated during this time span. The design makes it possible to operate the user interface following the entry of the input means without being distracted by the light strip, or respectively light strips.

Preferably, the intensity of a light emitted by the light strip can be modified depending on a position of the input means with respect to the border of the detection area. For example, the intensity can increase as the input means approaches the display apparatus, or respectively a central area of the detection area. Correspondingly, the intensity can conversely decrease when the input means grows distant from the central area of the detection area, or respectively crosses the border of the detection area in this direction. In this manner, the user receives direct feedback by the light strip as to whether the current movement of the input means is leading to such a position in which the user interface can be used, or respectively in the direction outside of the detection area.

Corresponding feedback on the position of the input means relative to the detection area can occur by a variation of a color of the light emitted by the light strip. For example, a green or blue color can identify a central position of the input means in the detection area that changes from yellow and orange to red as the input means gradually leaves the detection area. This embodiment reinforces the intuitive character of the display, or respectively the feedback to the user.

The aforementioned adaptation of the intensity and/or color depending on the position can be changed depending on the direction of the crossing relative to the detection area. Whereas a first direction describes an entry into the detection area, a second direction can describe a leaving of the detection area by the input means. When the center of the detection area is being approached, the change in intensity, or respectively color would therefore run in a first direction, whereas it is correspondingly reversed in an opposite direction. The corresponding can apply to an acoustic output, or respectively an acoustic indicator comprising at least two tones of different pitch, wherein the tone sequence that is reproduced upon crossing the border of the detection area in a first direction is reproduced upon subsequently leaving the detection area in the reverse direction. Such an acoustic feedback can supplement or replace part of the above-described embodiments of the display.

The design of the detection area can for example essentially be a pyramidal frustum depending on the employed sensor, wherein the surface of the display apparatus can be assigned to a minimal cross-sectional surface of the pyramidal frustum and enlarge the pyramidal frustum in the normal direction toward the surface of the display direction. Correspondingly, the pyramidal frustum can also be oriented toward a sensor instead of a surface of the display apparatus that is used to generate the detection area. Alternatively, the detection area can also be designed as a cube or conical frustum. Such a sensor can for example be designed as an infrared LED sensor or strip.

According to a second aspect of the present invention, a user interface is proposed to support a user in an interaction. The user interface can for example be designed for use in a means of transportation. It comprises a detection apparatus for detecting an input means (such as a hand, finger, stylus, smart watch or wearable), an evaluation unit (such as an electronic controller, a programmable processor, a microcontroller, or respectively nanocontroller) and a signaling apparatus by means of which feedback about the crossing of the detection area limit can be sent to the user. The signaling apparatus can be designed for acoustic feedback (such as in the form of a speaker) and/or for haptic feedback (such as in the form of a vibrator). However, the signaling apparatus at least comprises a means for generating a light strip in an edge area of a display apparatus of the user interface can therefore be realized by the display apparatus. The evaluation unit is configured to detect a crossing (i.e., a leaving or entrance) of an input means, of a border of a detection area for detecting gestures freely made in space. In response to the detected crossing, the signaling apparatus is configured to report the crossing by means of a light strip in an edge area of a display apparatus of the user interface.

According to a third aspect of the invention, a computer program product (such as a data memory) is proposed on which instructions are saved that make a programmable processor able to perform the steps of a method according to the first-cited aspect of the invention. The computer program product can be designed as a CD, DVD, Blu-ray disc, flash memory, hard disk, RAM/ROM, cache, etc.

According to a fourth aspect of the present invention, a signal sequence representing instructions is proposed that makes it possible for a programmable processor to perform the steps of a method according to the first-cited aspect of the invention. In this manner, the computerized provision of instructions is patented for the instance in which the required storage means fall outside of the scope of the accompanying claims.

According to a fifth aspect of the present invention, a means of transportation (such as a passenger car, transporter, truck, motorcycle, aircraft and/or watercraft) is provided that comprises a user interface according to the second-cited aspect of the invention. In this context, the user interface can be provided in particular for the driver of the means of transportation by means of which the driver can communicate with the means of transportation and its technical equipment while driving the means of transportation. Alternatively or in addition, accompanying passengers can use the user interface. The features, combinations of features and advantages resulting therefrom obviously correspond to those realized in conjunction with the method according to the invention, and reference will therefore be made to the above embodiments to avoid repetition.

The invention is based on the insight that optical sensors can better recognize free hand gestures within certain physical spaces than within others. For the user to know the space in which he needs to perform the gesture to control the graphic user interface, he can “scan” this space according to the invention. Once his hand is held in the predefined optimum space, the light strip shines as positive feedback (in particular in color). This feedback can last until the user moves the input means out of the space. In this manner, the user can “physically scan” the predefined space for detecting gestures and learn its limits. The abstract feedback that is represented by the light strip, or respectively the frame consisting of a plurality of light strips, is suitable for interfaces to be manipulated indirectly. In this manner, the user immediately understands that deictic gestures cannot be used, whereby misunderstandings that occur in the prior art can be avoided.

### BRIEF DESCRIPTION OF THE DRAWINGS

Exemplary embodiments of the invention will be described below in detail with reference to the accompanying drawings.

In the drawings:

FIG. 1 shows a schematic representation of components of an exemplary embodiment of a means of transportation designed according to the invention with an exemplary embodiment of a user interface designed according to the invention;

FIG. 2 shows an illustration of feedback of a first exemplary embodiment of a user interface according to the invention when an input means enters a detection area;

FIG. 3 shows an illustration of feedback of a second exemplary embodiment of a user interface according to the invention when an input means leaves a detection area;

FIG. 4 shows an illustration of feedback of a third exemplary embodiment of a user interface according to the invention when an input means enters a detection area;

FIG. 5 shows an illustration of feedback of a fourth exemplary embodiment of a user interface according to the invention when an input means leaves a detection area; and

FIG. 6 shows a flow chart illustrating steps of an exemplary embodiment of a method according to the invention for assisting a user during interaction with a user interface.

### EMBODIMENTS OF THE INVENTION

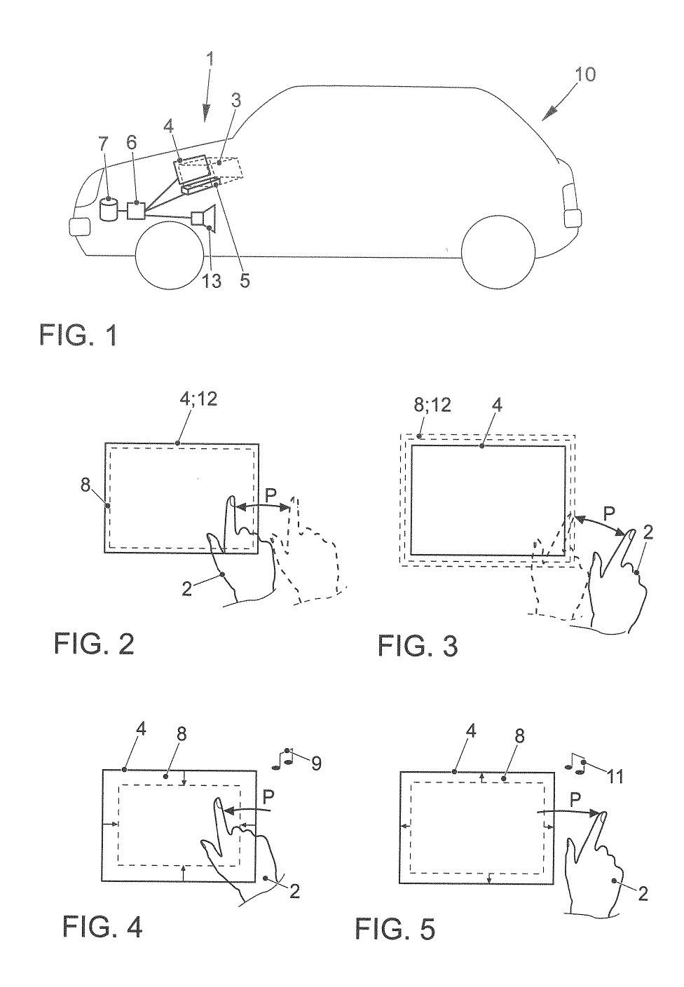

FIG. 1 shows a passenger car 10 as a means of transportation according to the invention that has a user interface 1 with a screen 4 as a display apparatus and an electronic controller 6 as an evaluation unit. An infrared LED strip 5 is provided below the screen 4 as a detection apparatus that covers a rectangular detection area 3 in front of the screen 4. A data memory 7 is configured to provide program codes for executing the method according to the invention, as well as references for signals of the infrared LED strip 5 when an input means crosses a border of the detection area 3. The electronic controller 6 is connected by IT in a radial manner to the aforementioned components. A speaker 13 is connected by IT to the electronic controller 6 so that an acoustic output of a sound indicator can underscore the display of the crossing.

FIG. 2 shows the screen 4 shown in FIG. 1 whose edge area (pixels of the display surface for displaying an optional content) is used to depict a light strip 8 in order to display, or respectively report the entry of a hand 2 that moves along a double arrow P across the border of the detection area toward a central position before the screen 4. The light strip 8 consists of four substantially linear elements that assume a plurality of respective outermost pixels along the four edges of the screen 4. The light strip 8 can therefore be understood as a light frame. It shines while the hand 2 of the user crosses the border of the detection area and goes dark once the crossing is entirely completed. The intensity of the light emitted by the light strip 8 during the crossing can occur like a swelling or respectively, attenuating dimming process to calm the visual appearance and comprise a color change of the emitted light. Conversely, the signaling would occur when the hand of the user subsequently leaves the detection area in front of the screen 4 (for example following input). Since the screen 4 is used to signal, or respectively generate the light strip, it can also be understood as a signaling apparatus 12.

FIG. 3 shows an alternative embodiment to FIG. 2 of a signaling apparatus 12 that borders the screen 4 in the form of a separate light outlet. Whereas the function substantially corresponds to that described in conjunction with FIG. 2, the light strip 8 can be designed independent of the options of the screen 4, in particular with regard to the maximum possible intensity of the light emitted by the separate signaling apparatus 12. Alternatively or in addition, the emitted light can be generated as indirect light in that the light strip 8 is generated behind an opaque screen, and shines into the surroundings of the screen 4. This embodiment enables a light strip 8 that is visually particularly attractive, subdued and minimally distracting.

FIG. 4 shows another embodiment of a user interface according to the invention in which the crossing of the hand 2 is acknowledged by a light strip 8 with a width, or respectively strength that grows from the outside to the inside. Neighboring pixels toward the middle of the screen 4 help the pixels close to the edge of the screen 4 generate the light strip 8 over time. Visually, the light strip 8, or respectively the light frame formed by a plurality of light strips 8, swells. Optionally, the feedback to the user is accompanied by the emission of a first sound indicator 9 in the form of an interrupted two-note sound of rising pitch.

FIG. 5 shows a situation subsequent to the situation shown in FIG. 4 in which the user's hand 2 leaves the detection area in front of the screen 4, in response to which the light strip 8 fades such that the pixels closest toward the middle of the screen (middle horizontal, or respectively middle vertical) first reduce their light intensity, and then pixels further from the middle of the screen are dimmed. The exit of the hand 2 along arrow P is also underscored by a sound indicator 11, this time in the form of an interrupted two-tone sound of decreasing pitch, whereby the user recognizes that he has just left the detection area for 3D gesture detection without directing his attention to the user interface.

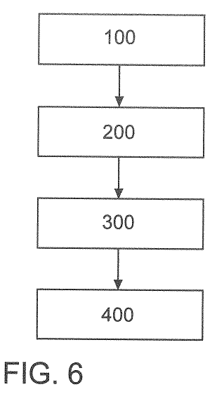

FIG. 6 shows steps of an exemplary embodiment of a method according to the invention for assisting a user during interaction with a user interface. In step 100, a crossing of a detection area border by a user's input means for detecting gestures freely made in space is detected. The crossing can be entering or leaving the detection area, or respectively a section of the detection area (such as the core area, edge area, etc.). Then in step 200, a light strip is formed by the light strip widening in the direction of the middle of the user interface display apparatus. In step 300, the maximum width of the light strip has formed in an edge area of the display apparatus, and the input means has fully entered the detection area. By performing 3D gestures, the user can now communicate with the user interface, or respectively a technical apparatus associated therewith. After the input, the user leaves the detection area in step 400, in response to which a light strip is reduced by the light strip narrowing toward an edge area of the display apparatus. This decrease occurs as a dimming process also in terms of the overall intensity of the emitted light up to complete disappearance of the light strip. Consequently, the feedback to the user about the crossing of the border of a detection area occurs in a more intuitively understandable, visually attractive and subdued manner so that user acceptance of a correspondingly designed user interface is increased, and driving safety is improved.

Although the aspects and advantageous embodiments according to the invention were explained in detail with reference to the exemplary embodiments explained in conjunction with the associated drawings, modifications and combinations of features of the depicted exemplary embodiments are possible for a person skilled in the art without departing from the ambit of the present invention whose scope of protection is defined by the accompanying claims.

### REFERENCE NUMBER LIST

1 User interface
2 Hand
3 Detection area
4 Screen
5 Infrared LED strip
6 Electronic controller
7 Data memory
8 Light strip
9 Sound indicator
10 Passenger car
11 Sound indicator
12 Signaling apparatus
13 Speaker
100-400 Method steps
P Arrow

1. A method for assisting a user during interaction with a user interface (1) comprising the steps:
Detection (100) of a crossing of a detection area (3) border by a user's input means (2) for detecting gestures freely made in space, and in response thereto
Display (300) of the crossing by means of a light strip (8) in an edge area of a display apparatus (4) of the user interface (1).

2. The method according to claim 1, wherein the light strip (8) is depicted by means of pixels of the display apparatus (4).

3. The method according to claim 1 or 2, wherein the light strip (8) borders an edge, preferably all edges, of the display apparatus (4).

4. The method according to one of the preceding claims, wherein the light strip (8) is only displayed for the duration of the crossing.

5. The method according to one of the preceding claims, wherein an intensity of the light strip (8) is modified depending on a position of the input means (2) with respect to the border of the detection area (3).

6. The method according to one of the preceding claims, wherein a color of the light strip (8) is modified depending on a position of the input means (2) with respect to the border of the detection area (3).

7. The method according to one of the preceding claims, wherein the direction of a
change in color and/or
a change in intensity of the light strip is changed depending on a direction of the crossing with respect to the detection area (3).

8. The method according to one of the preceding claims, moreover comprising the step:
Increasing (200) the light strip (8) by widening the light strip (8) toward the middle of the display apparatus (4), or
decreasing (400) the light strip (8) by narrowing the light strip (8) toward an edge area of the display apparatus (4).

9. The method according to one of the preceding claims, wherein the input means (2) comprises a hand and/or a finger of a user.

10. The method according to one of the preceding claims, wherein the border of the detection area (3) covers a pyramidal frustum, and/or a conical frustum, and/or a cubic space.

11. The method according to one of the preceding claims, wherein
the crossing in a first direction with respect to the detection area (3) is accompanied by a first sound indicator (9), and
the crossing in a second direction with respect to the detection area (3) is accompanied by a second sound indicator (11), and
wherein the first direction and second direction differ, and in particular
the first sound indicator (9) and second sound indicator (11) differ.

12. A user interface for assisting a user with an interaction comprising
a detection apparatus (5) for detecting an input means of a user,
an evaluation unit (6) and
a signaling apparatus (12), wherein
the evaluation unit (6) is configured to detect a crossing of a detection area (3) border by a user's input means (2) for detecting gestures freely made in space, and,
the signaling apparatus (12) is configured to report, in response to the crossing, the crossing by means of a light strip (8) in an edge area of a display apparatus (4) of the user interface (1).

13. A computer program product comprising instructions that, when they are run on a programmable evaluation unit (6) of the user interface (1) according to claim 12, they cause the evaluation unit (6) to perform the steps of a method according to one of claims 1 to 11.

14. A signal sequence representing instructions that, when they are run on a programmable evaluation unit (6) of the user interface (1) according to claim 12, they cause the evaluation unit (6) to perform the steps of a method according to one of claims 1 to 11.

15. A means of transportation comprising a user interface according to claim 12.
